(19) United States
(12) Patent Application Publication
(10) Pub. No.: US 2026/0213209 A1
(43) Pub. Date: Jul. 23, 2026

(54) NON-CARBON GROUP IVB-BASED NITRIDES AS CONDUCTIVE ADDITIVES FOR ALL-SOLID-STATE BATTERY CELLS

(71) Applicant: GM GLOBAL TECHNOLOGY OPERATIONS LLC, Detroit, MI (US)

(72) Inventors: Yong LU, Shanghai (CN); Zhe LI, Shanghai (CN); Haijing LIU, Shanghai (CN)

(21) Appl. No.: 19/452,998

(22) Filed: Jan. 20, 2026

(30) Foreign Application Priority Data
Jan. 21, 2025 (CN) 202510095895X

(51) Int. Cl. H01M 4/62; H01M 4/02; H01M 4/13; H01M 10/0562; H01M 10/0585

(52) U.S. Cl. CPC H01M 4/626; H01M 4/13; H01M 10/0562; H01M 10/0585; H01M 2004/027; H01M 2004/028; H01M 2300/0068; H01M 2300/008

(57) ABSTRACT

An all-solid-state battery cell includes C cathode electrodes including a cathode active material layer arranged on one or both sides of a cathode current collector, A anode electrodes including an anode active material layer arranged on one or both sides of an anode current collector, and S separators arranged between corresponding ones of the A anode electrodes and the C cathode electrodes. At least one of the cathode active material layer, the anode active material layer, and the S separators includes a solid electrolyte. At least one of the cathode active material layer and the anode active material layer includes a conductive additive including a transition metal nitride. The transition metal nitride is selected from a group consisting of Group IVb nitrides, poly-nary nitrides, and combinations thereof.

### CROSS-REFERENCE TO RELATED APPLICATIONS

This application claims the benefit of Chinese Patent Application No. 202510095895.X, filed on Jan. 21, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to conductive additives in electrodes of all-solid-state battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An all-solid-state battery cell includes C cathode electrodes including a cathode active material layer arranged on one or both sides of a cathode current collector, A anode electrodes including an anode active material layer arranged on one or both sides of an anode current collector, and S separators arranged between corresponding ones of the A anode electrodes and the C cathode electrodes. At least one of the cathode active material layer, the anode active material layer, and the S separators includes a solid electrolyte. At least one of the cathode active material layer and the anode active material layer includes a conductive additive including a transition metal nitride.

In other features, the transition metal nitride has a rock salt phase and a sodium chloride structure. The cathode active material layer includes a cathode active material in a range from 50 to 99.4 wt %, the solid electrolyte in a range from 0 to 50 wt %, a binder in a range from 0.1 to 20 wt %; and the transition metal nitride in a range from 0.5 to 6 wt %.

In other features, the S separators comprise a solid electrolyte in a range from 80 to 100 wt % and a binder comprising 0 to 20 wt %.

In other features, the anode active material layer includes an anode active material in a range from 50 to 99.4 wt %, the solid electrolyte in a range from 0 to 50 wt %, a binder in a range from 0.1 to 20 wt %; and the transition metal nitride in a range from 0.2 to 5 wt %.

In other features, the transition metal nitride is selected from a group consisting of Group IVb nitrides, poly-nary nitrides, and combinations thereof. The Group IVb nitrides include a metal selected from a group consisting of titanium (Ti), zirconium (Zr), hafnium (Hf), and combinations thereof. The poly-nary nitrides include group IVb nitrides with a transition metal partially substituted by at least one of a group Vb metal selected from a group consisting of vanadium (V), niobium (Nb), and tantalum (Ta), and a group VIb metal selected from a group consisting of chromium (Cr), molybdenum (Mo), and tungsten (W).

In other features, the cathode active material is selected from a group consisting of rock salt layered oxides, spinel, polyanion cathode material, and a lithium transition-metal oxide. The cathode active material includes at least one of a surface-coated cathode active material and a doped cathode active material. The cathode active material is selected from a group consisting of a lithiated metal oxide/sulfide, lithium sulfide, sulfur, and combinations thereof.

In other features, the anode active material is selected from a group consisting of a silicon (Si)-based material, a carbonaceous material, and a metal oxide. The solid electrolyte is selected from a group consisting of pseudobinary sulfide, pseudoternary sulfide, pseudoquaternary sulfide, and a halide-based solid electrolyte.

An all-solid-state battery cell includes C cathode electrodes including a cathode active material layer arranged on one or both sides of a cathode current collector, A anode electrodes including an anode active material layer arranged on one or both sides of an anode current collector, and S separators arranged between corresponding ones of the A anode electrodes and the C cathode electrodes. C, A, and S are integers greater than one. At least one of the cathode active material layer, the anode active material layer, and the S separators includes a sulfide solid electrolyte. At least one of the cathode active material layer and the anode active material layer includes a conductive additive including a transition metal nitride. The transition metal nitride is selected from a group consisting of Group IVb nitrides, poly-nary nitrides, and combinations thereof. The transition metal nitride has a rock salt phase and a sodium chloride structure.

In other features, the cathode active material layer includes a cathode active material in a range from 50 to 99.4 wt %, the sulfide solid electrolyte in a range from 0 to 50 wt %, a binder in a range from 0.1 to 20 wt %, and the transition metal nitride in a range from 0.5 to 6 wt %.

In other features, the anode active material layer includes an anode active material in a range from 50 to 99.4 wt %, the sulfide solid electrolyte in a range from 0 to 50 wt %, a binder in a range from 0.1 to 20 wt %, and the transition metal nitride in a range from 0.2 to 5 wt %.

In other features, the S separators comprise a solid electrolyte in a range from 80 to 100 wt % and a binder comprising 0 to 20 wt %. The Group IVb nitrides include a metal selected from a group consisting of titanium (Ti), zirconium (Zr), hafnium (Hf), and combinations thereof. The poly-nary nitrides comprise group IVb nitrides with a transition metal partially substituted by at least one of a group Vb metal selected from a group consisting of vanadium (V), niobium (Nb), and tantalum (Ta), and a group VIb metal selected from a group consisting of chromium (Cr), molybdenum (Mo), and tungsten (W).

In other features, the cathode active material is selected from a group consisting of rock salt layered oxides, spinel, polyanion cathode material, and a lithium transition-metal oxides. The anode active material is selected from a group consisting of a silicon (Si)-based material, a carbonaceous material, and a metal oxide.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of an all-solid state battery cell include A anode electrodes, C cathode electrodes, and S separators according to the present disclosure;

FIG. 2 is an enlarged view of the all-solid state battery cell of FIG. 1;

FIG. 3 is an enlarged view of one of the C cathode electrodes according to the present disclosure;

FIG. 4 is an enlarged view of one of the S separators according to the present disclosure;

FIG. 5 is an enlarged view of one of the A anode electrodes according to the present disclosure;

FIG. 6 is a charge-discharge curve for an example of an all-solid-state battery cell with and without a transition metal nitride as a conductive additive in the anode electrode; and

FIG. 7 is a discharge rate curve at room temperature for an example of an all-solid-state battery cell with and without a transition metal nitride as a conductive additive in the anode electrode.

In the drawings, reference numbers may be reused to identify similar and/or identical elements.

### DETAILED DESCRIPTION

While the battery cells are described herein in the context of vehicles, the battery cells can be used in other mobile and/or stationary applications.

A lithium ion battery cell includes cathode electrodes, anode electrodes, and separators arranged between the cathode electrodes and the anode electrodes. The anode electrodes and/or cathode electrodes typically include active material, one or more conductive carbon additives, and a binder. The one or more conductive carbon additives boost electron conduction within the anode electrodes and/or cathode electrodes, which will further benefit the power capability of the battery cells. However, in sulfide-based all-solid-state battery (S-ASSB) cells, the one or more conductive carbon additives cause decomposition of the sulfide solid electrolytes.

To mitigate the side reactions between sulfide solid electrolyte and the one or more conductive carbon additives in the anode electrodes and/or cathode electrodes, the one or more conductive carbon additives are replaced with one or more transition metal nitrides (TMNs) to ensure the electronic conduction. Transition metal nitrides exhibit electronic conductivity due to partially filled valence d orbitals that are not completely hybridized with N-2p electrons. For example, the bulk electronic conductivity of titanium nitride (TiN) reaches 5×10⁴ Siemens/cm (S/cm). In some examples, the one or more TMNs have a rock salt phase and a sodium chloride (NaCl) crystal structure.

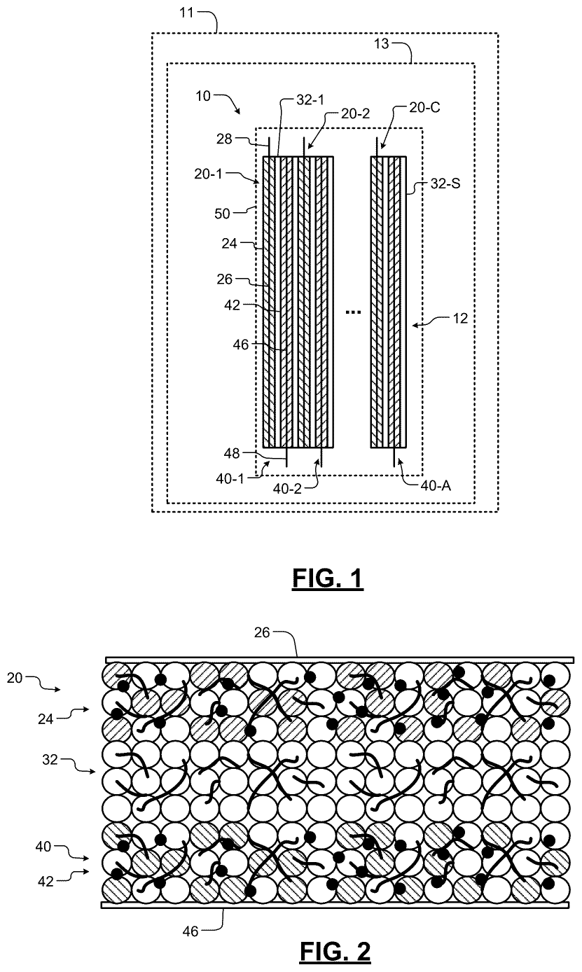

Referring now to FIG. 1, a solid-state battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the solid-state battery cell 10. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 arranged one or both sides of an anode current collector 46.

During charging/discharging, the A anode electrodes 40 and the C cathode electrodes 20 exchange lithium ions. In some examples, the cathode active material layers 24 and/or anode active material layers 42 comprise coatings including one or more active materials, solid electrolytes, one or more conductive additives, and/or one or more binder materials that are applied to the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2 to 5, either the C cathode electrodes or the A anode electrodes or both the C cathode electrodes and the A anode electrodes of the S-ASSB cells include a conductive additive including one or more transition metal nitride (TMNs).

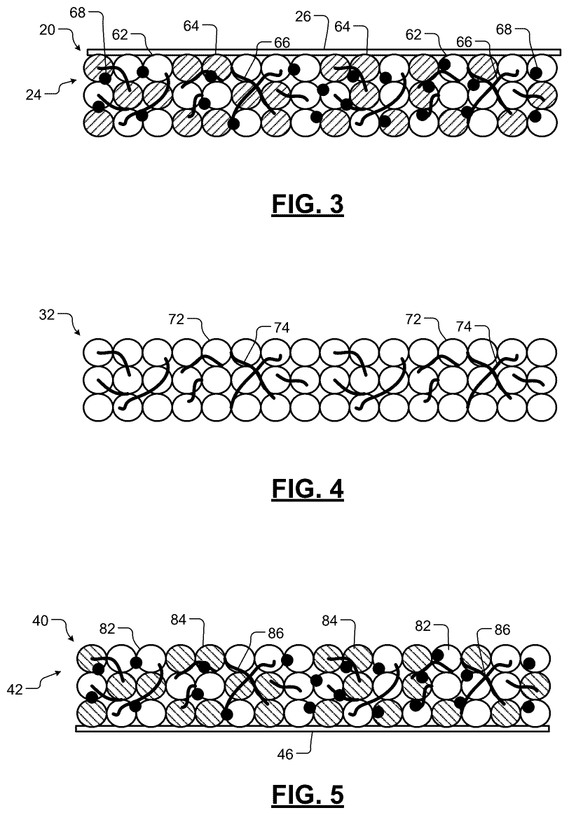

In FIG. 3, one of the C cathode electrodes 20 is shown to include the cathode active material layer 24 arranged on the cathode current collector 26. The cathode active material layer 24 includes a cathode active material 62, a solid electrolyte 64 (e.g., sulfide solid electrolyte), a binder 66, and a conductive additive 68. In some examples, the conductive additive 68 includes one or more transition metal nitride (TMNs).

In some examples, the cathode active material layer 24 includes TMNs in a range from 0.5 to 6 wt %. In some examples, the cathode active material layer 24 does not include conductive carbon filler. In some examples, the cathode active material layer 24 includes TMNs in a range from 1 to 3 wt %. The C cathode electrodes 20 include the cathode active material 62 in a range from 50 to 99.4 wt %, the solid electrolyte 64 in a range from 0 to 50 wt %, and the binder 66 in a range from 0.1 to 20 wt %. In some examples, the cathode active material 62 comprises greater than 70 wt % and less than 99.4 wt % of the cathode active material layer 24. In some examples, the solid electrolyte 64 comprises sulfide solid electrolyte. In some examples, the solid electrolyte 64 comprises in a range from 0 to 30 wt %. In some examples, the binder 66 comprises a thermoplastic binder. In some examples, the binder 66 comprises in a range from 0.1 to 10 wt %.

In FIG. 4, one of the S separators 32 is shown to include solid electrolyte 72 and a binder 74. In some examples, the binder 74 comprises a thermoplastic binder. In some examples, the separator 32 comprises solid electrolyte in a range from 80 to 100 wt % and a binder comprising 0 to 20 wt %. In some examples, the separator 32 comprises solid electrolyte in a range from 90 to 100 wt % and a binder comprising 0 to 10 wt %.

In FIG. 5, one of the A anode electrodes 40 is shown to include the anode active material layer 42 arranged on the anode current collector 46. The anode active material layer 42 includes anode active material 82, a solid electrolyte 84, a binder 86, and a conductive additive 88. In some examples, the conductive additive 88 includes one or more transition metal nitride (TMNs).

In some examples, the anode active material layer 42 includes TMNs in a range from 0.2 to 5 wt %. In some examples, the anode active material layer 42 does not include conductive carbon filler. In some examples, the anode active material layer 42 includes TMNs in a range from 0.5 to 2 wt %. The A anode electrodes 40 include the anode active material 82 in a range from 50 to 99.4 wt %, the solid electrolyte 84 in a range from 0 to 50 wt %, and the binder 86 in a range from 0.1 to 20 wt %. In some examples, the anode active material 82 comprises greater than 70 wt % and less than 99.4 wt % of the anode active material layer 42. In some examples, the solid electrolyte 84 comprises sulfide solid electrolyte. In some examples, the solid electrolyte 84 comprises in a range from 0 to 30 wt %. In some examples, the binder 86 comprises a thermoplastic binder. In some examples, the binder 86 comprises in a range from 0.1 to 10 wt %.

In some examples, the TMNs are electrically conductive. In some examples, the TMNs have a rock salt phase and a sodium chloride structure. In some examples, the TMNs are selected from a group consisting of Group IVb nitrides and poly-nary nitrides.

In some examples, the Group IVb nitrides include a metal selected from a group consisting of titanium (Ti), zirconium (Zr), hafnium (Hf), and combinations thereof. In some examples, the TMN may include titanium nitride (TiN), zirconium nitride (ZrN), and hafnium nitride (HfN). In other examples, the TMN may include a binary system such as titanium zirconium nitride (TiₓZr₁₋ₓN), titanium hafnium nitride (TiₓHf₁₋ₓN), and zirconium hafnium nitride (ZrₓHf₁₋ₓN), where 0<x<1.

In some examples, metals in Group IVb nitrides are partially substituted by at least one of the group Vb elements (vanadium (V), niobium (Nb), tantalum (Ta)) and/or group VIb elements (chromium (Cr), molybdenum (Mo), tungsten (W)) to form poly-nary nitrides. Examples of poly-nary nitrides include TiₓV₁₋ₓN, TiₓNb₁₋ₓN, TiₓTa₁₋ₓN, TiₓCr₁₋ₓN, TiₓMo₁₋ₓN, TiₓW₁₋ₓN, ZrₓV₁₋ₓN, ZrₓNb₁₋ₓN, ZrₓTa₁₋ₓN, ZrₓCr₁₋ₓN, ZrₓMo₁₋ₓN, ZrₓW₁₋ₓN, HfₓV₁₋ₓN, HfₓNb₁₋ₓN, HfₓTa₁₋ₓN, HfₓCr₁₋ₓN, HfₓMo₁₋ₓN, and HfₓW₁₋ₓN, where 0<x<1.

In some examples, the cathode active material is selected from a group consisting of a rock salt layered oxide, a spinel, a polyanion cathode material, and/or other lithium transition-metal oxides. Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, Li₁₊ₓMO₂, and combinations thereof, where 0<x<1 and 0<y<1. Examples of the spinel include LiMn₂O₄, LiNi_{0.5}Mn_{1.5}O₄, and combinations thereof. Examples of the polyanion cathode include LiV₂(PO₄)₃.

In some examples, the cathode active material includes surface-coated and/or doped cathode materials mentioned above. In some examples, the cathode active material includes lithium niobate (LiNbO₃)-coated LiMn₂O₄ or Li₂ZrO₃. For example, the cathode active material includes lithium phosphate (Li₃PO₄)-coated LiNiₓMn_{y}Co_{1-x-y}O₂. In some examples, the cathode active material includes Al-doped LiMn₂O₄.

In some examples, the cathode active material includes low voltage cathode material such as lithiated metal oxide/sulfide (e.g., LiTiS₂), lithium sulfide, sulfur, and combinations thereof.

In some examples, the anode active material includes at least one of a silicon (Si)-based material, a carbonaceous material, and a metal oxide. In some examples, the Si-based material includes Si, silicon oxide (SiOₓ), lithium silicon oxide (LiSiOₓ), silicon and carbon (Si/C), SiOₓ/C, LiSiOₓ/C, and combinations thereof. In some examples, the carbonaceous material includes graphite, hard carbon, soft carbon, and combinations thereof. Examples of metal oxides include tix oxide (SnO₂) and iron oxide (Fe₃O₄).

Examples of binders include hydrogenated acrylonitrile butadiene rubber (HNBR), nitrile butadiene rubber (NBR), styrene-butadiene-styrene (SBS), styrene ethylene butylene styrene (SEBS), SEPTON materials (e.g., styrene-[ethylene-(ethylene-propylene)]-styrene (SEEPS), styrene ethylene butylene styrene (SEPS), styrene ethylene butylene (SEP), etc.), poly(vinylidene fluoride-co-Hexafluoropropylene) (PVDF-HFP).

In some examples, the solid electrolyte is selected from a group consisting of pseudobinary sulfide, pseudoternary sulfide, pseudoquaternary sulfide, and a halide-based solid electrolyte.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system.

Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄, and Li₁₁Si₂PS₁₂

Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

Examples of halide-based solid electrolyte. e.g., Li₃MX₆ (M=Y, In, Zr, Sc, Er etc. X=Cl, Br, I), Li₂MX₄ (M=Cd, Mg, Zn etc.; X=Cl, Br, I) , and Li₃OCl.

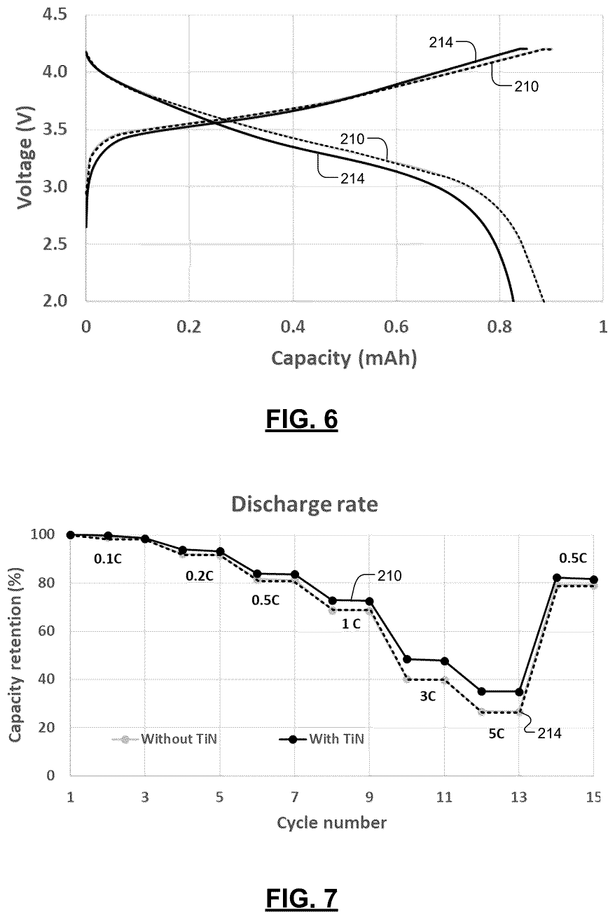

Referring now to FIGS. 2, 6, and 7, performance of an example of an all-solid-state battery cell is shown. In FIGS. 6 and 7, the all-solid-state battery is shown without the TMNs as the conductive additive in the anode electrode at 210 and with the TMNs as the conductive additive in the anode electrode at 214. Both the cathode electrodes at 210 and 214 include NCM 523, argyrodite-Li₆PS₅Cl (LPSCl), and Super P at 53.2/42.5/4.3 wt %. The anode electrode at 210 includes Si/SEEPS/LPSCl at 70/25/5 wt %. The anode electrode at 214 includes Si/SEEPS/LPSCl/TiN at 67.2/4.8/24/4.0 wt %. As can be seen, introducing a transition metal nitride such as TiN into the anode electrode enhances the discharge rate at room temperature.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. An all-solid-state battery cell, comprising:
C cathode electrodes including a cathode active material layer arranged on one or both sides of a cathode current collector;
A anode electrodes including an anode active material layer arranged on one or both sides of an anode current collector; and
S separators arranged between corresponding ones of the A anode electrodes and the C cathode electrodes, where C, A, and S are integers greater than one,
wherein at least one of the cathode active material layer, the anode active material layer, and the S separators includes a solid electrolyte, and
wherein at least one of the cathode active material layer and the anode active material layer includes a conductive additive including a transition metal nitride.

2. The all-solid-state battery cell of claim 1, wherein the transition metal nitride has a rock salt phase and a sodium chloride structure.

3. The all-solid-state battery cell of claim 1, wherein the cathode active material layer includes:
a cathode active material in a range from 50 to 99.4 wt %,
the solid electrolyte in a range from 0 to 50 wt %,
a binder in a range from 0.1 to 20 wt %; and
the transition metal nitride in a range from 0.5 to 6 wt %.

4. The all-solid-state battery cell of claim 1, wherein the S separators comprise a solid electrolyte in a range from 80 to 100 wt % and a binder comprising 0 to 20 wt %.

5. The all-solid-state battery cell of claim 1, wherein the anode active material layer includes:
an anode active material in a range from 50 to 99.4 wt %,
the solid electrolyte in a range from 0 to 50 wt %,
a binder in a range from 0.1 to 20 wt %; and
the transition metal nitride in a range from 0.2 to 5 wt %.

6. The all-solid-state battery cell of claim 1, wherein the transition metal nitride is selected from a group consisting of Group IVb nitrides, poly-nary nitrides, and combinations thereof.

7. The all-solid-state battery cell of claim 6, wherein the Group IVb nitrides include a metal selected from a group consisting of titanium (Ti), zirconium (Zr), hafnium (Hf), and combinations thereof.

8. The all-solid-state battery cell of claim 6, wherein the poly-nary nitrides include group IVb nitrides with a transition metal partially substituted by at least one of:
a group Vb metal selected from a group consisting of vanadium (V), niobium (Nb), and tantalum (Ta), and
a group VIb metal selected from a group consisting of chromium (Cr), molybdenum (Mo), and tungsten (W).

9. The all-solid-state battery cell of claim 3, wherein the cathode active material is selected from a group consisting of rock salt layered oxides, spinel, polyanion cathode material, and a lithium transition-metal oxide.

10. The all-solid-state battery cell of claim 3, wherein the cathode active material includes at least one of a surface-coated cathode active material and a doped cathode active material.

11. The all-solid-state battery cell of claim 3, wherein the cathode active material is selected from a group consisting of a lithiated metal oxide/sulfide, lithium sulfide, sulfur, and combinations thereof.

12. The all-solid-state battery cell of claim 5, wherein the anode active material is selected from a group consisting of a silicon (Si)-based material, a carbonaceous material, and a metal oxide.

13. The all-solid-state battery cell of claim 1, wherein the solid electrolyte is selected from a group consisting of pseudobinary sulfide, pseudoternary sulfide, pseudoquaternary sulfide, and a halide-based solid electrolyte.

14. An all-solid-state battery cell, comprising:
C cathode electrodes including a cathode active material layer arranged on one or both sides of a cathode current collector;
A anode electrodes including an anode active material layer arranged on one or both sides of an anode current collector; and
S separators arranged between corresponding ones of the A anode electrodes and the C cathode electrodes, where C, A, and S are integers greater than one,
wherein at least one of the cathode active material layer, the anode active material layer, and the S separators includes a sulfide solid electrolyte,
wherein at least one of the cathode active material layer and the anode active material layer includes a conductive additive including a transition metal nitride,
wherein the transition metal nitride is selected from a group consisting of Group IVb nitrides, poly-nary nitrides, and combinations thereof,
wherein the transition metal nitride has a rock salt phase and a sodium chloride structure.

15. The all-solid-state battery cell of claim 14, wherein the cathode active material layer includes:
a cathode active material in a range from 50 to 99.4 wt %,
the sulfide solid electrolyte in a range from 0 to 50 wt %,
a binder in a range from 0.1 to 20 wt %; and
the transition metal nitride in a range from 0.5 to 6 wt %.

16. The all-solid-state battery cell of claim 15, wherein the anode active material layer includes:
an anode active material in a range from 50 to 99.4 wt %,
the sulfide solid electrolyte in a range from 0 to 50 wt %,
a binder in a range from 0.1 to 20 wt %; and
the transition metal nitride in a range from 0.2 to 5 wt %.

17. The all-solid-state battery cell of claim 14, wherein the S separators comprise a solid electrolyte in a range from 80 to 100 wt % and a binder comprising 0 to 20 wt %.

18. The all-solid-state battery cell of claim 14, wherein the Group IVb nitrides include a metal selected from a group consisting of titanium (Ti), zirconium (Zr), hafnium (Hf), and combinations thereof.

19. The all-solid-state battery cell of claim 14, wherein the poly-nary nitrides comprise group IVb nitrides with a transition metal partially substituted by at least one of:
a group Vb metal selected from a group consisting of vanadium (V), niobium (Nb), and tantalum (Ta), and
a group VIb metal selected from a group consisting of chromium (Cr), molybdenum (Mo), and tungsten (W).

20. The all-solid-state battery cell of claim 16, wherein:
the cathode active material is selected from a group consisting of rock salt layered oxides, spinel, polyanion cathode material, and a lithium transition-metal oxides, and
the anode active material is selected from a group consisting of a silicon (Si)-based material, a carbonaceous material, and a metal oxide.
